(19) United States
(12) Patent Application Publication
(10) Pub. No.: US 2016/0002953 A1
(43) Pub. Date: Jan. 7, 2016

(54) ELECTRONIC TIME LOCK

(71) Applicant: Jeffrey Sada, Corte Madera, CA (US)

(72) Inventor: Jeffrey Sada, Corte Madera, CA (US)

(21) Appl. No.: 14/753,112

(22) Filed: Jun. 29, 2015

Related U.S. Application Data
(60) Provisional application No. 62/019,636, filed on Jul. 1, 2014.
(60) Provisional application No. 62/038,439, filed on Aug. 18, 2014.

(51) Int. Cl. E05B 43/00; E05B 47/00; E05B 67/38

(52) U.S. Cl. CPC E05B 43/005; E05B 67/38; E05B 47/0012

(57) ABSTRACT

An electrically operated lockset comprising a lock bolt; a lock housing; a mechanical lockset capable of being locked and unlocked by a lock actuator; a plurality of programmable buttons on the exterior of the lock housing to electrically control a lock actuator fitted within the lock housing to operate a locking element moveable from a locked position to an unlocked position; a timing mechanism countdown controlled by the programmable buttons; and display screen for a timing countdown.

### RELATED APPLICATIONS

This application claims priority to U.S. Provisional Application No. 62/019,636 filed Jul. 1, 2014 and U.S. Provisional Application No. 62/038,439 filed Aug. 18, 2014. The entire contents of the above applications are hereby incorporated by reference as though fully set forth herein.

### FIELD

The present invention relates to the field of locking mechanisms. More specifically, the present invention relates to a time-release electronic lock.

### BACKGROUND

Lock timers and time delay mechanisms have frequently been used to delay the opening of a safe or a vault door and they are commonly used in bank vaults and other high security containers. Commercially available time locks generally use a timer designed to prevent the opening of the lock even if the correct combination(s) are known. Generally, the time locks are mounted on the inside of the safe or vault door. Time-delay combination locks are also commercially available in which a digital, electronic combination lock is equipped with a delay timer that delays the unlocking of the lock by a user for a preset delay period. While time locks unlock at a preset time, time-delay locks create a set delay period to elapse before the lock can be opened.

### PRIOR ART

There have been attempts in the prior art to create an inexpensive, dependable time delay unit useable with a combination lock to prevent the lock from opening for a predetermined time interval after opening manipulation of the lock. For example, U.S. Pat. No. 3,481,166 to Lingal discloses an attachment that is secured directly to a combination lock. Additionally, U.S. Pat. No. 5,451,934 to Dawson et. al. discloses a time-delay electronic lock that requires the use of a combination and access number to open the lock. Finally, there are containers that have a timed locking mechanism where the container lid cannot be opened until the timer reaches zero.

However, there still exists a need for an inexpensive lock that is not limited to use with a specific container and does not require a combination or access code but rather can be opened at the end of a programmed time-delay period.

### BRIEF SUMMARY OF THE INVENTION

The present invention seeks to meet this need by providing a locking device that uses a time-delay mechanism to program the lock to open at the end of a preset time period, without the use of a combination or access code. The locking device is primarily intended to function as a discipline tool to keep users away from distractions such as cell phones, laptops, tablets and even food. The locking device is versatile in that it can be used on multiple containers, such as bags with a double zippers wherein the lock is placed between the holes on each zipper in order to keep the zipper mechanism of the bag in the closed position.

Generally, the present invention is an electrically operated lockset comprising a lock bolt; a lock housing; a mechanical lockset capable of being locked and unlocked by a lock actuator; a plurality of programmable buttons on the exterior of the lock housing to electrically control a lock actuator fitted within the lock housing to operate a locking element moveable from a locked position to an unlocked position; a timing mechanism countdown controlled by the programmable buttons; and display screen for a timing countdown. The lock bolt is removably fastenable to the lock housing. The lock actuator and programmable buttons are operable by battery or other electrical power source. The lock housing substantially surrounds the motor and the display screen is on an exterior surface of the lock housing

### BRIEF DESCRIPTION OF THE DRAWINGS

FIG. 1. FIG. 1 is perspective view of the top side of the electronic locking device.

FIG. 2. FIG. 2 is perspective view of the bottom side of the electronic locking device.

### DETAILED DESCRIPTION

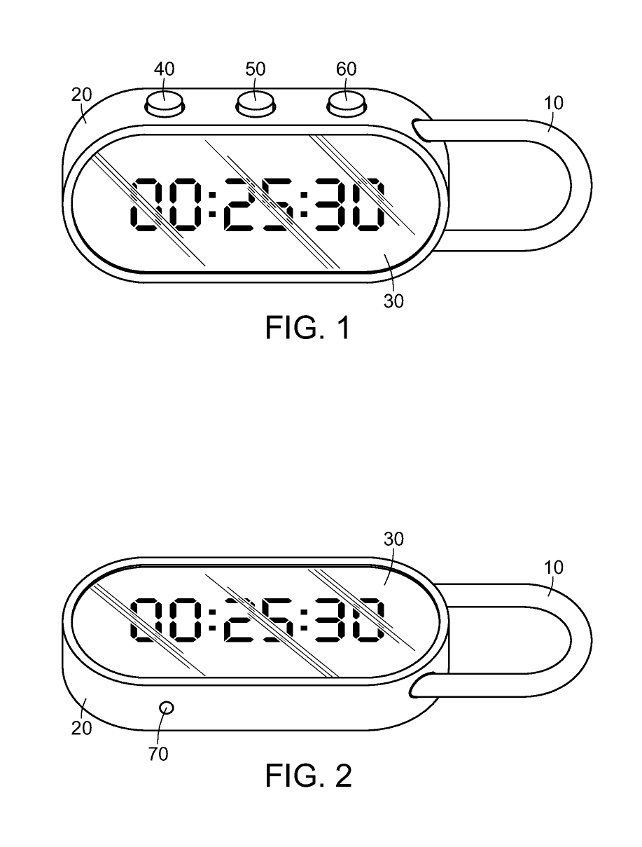

Turning to FIGS. 1-2, the present invention is an electronic time lock comprised generally of a shackle (or bolt) 10, a body 20, a time lock mechanism with a display unit 30 and programmable buttons 40 and 60, and a lock button 50. The shackle (or bolt) 10 can be constructed from a variety of materials, including but not limited to plastic coated wire, polymeric materials, zinc alloy, aluminum, stainless steel, rubber or combinations thereof. In the preferred embodiment shown in FIGS. 1-2, the body 20 is oval in shape; however, it is contemplated the body may be of any shape to accommodate the locking mechanism located in the interior cavity of the body 20. The body 20 can also be constructed from a variety of materials such as plastic, polymeric materials, zinc allow, aluminum, stainless steel, and combinations thereof

While several locking mechanisms may be used with the present invention, such as a pin-tumbler, a warded locking mechanism and/or other actuator devices that interface with the shackle (or bolt), in the preferred embodiment of the present invention a motorized lock is used. For example, a small electric motor may turn a series of spur gears that serve as a gear reduction. The last gear drives a rack-and-pinion gearset that is connected to the actuator rod. The rack converts the rotational motion of the motor into the linear motion needed to move the lock. Various other motorized actuators that are known in the prior art may also be used.

In a second embodiment, the locking mechanism comprises generally a locking solenoid, a lock cavity, and an electromagnetic power source. The locking solenoid is a small wire coil that is magnetized when paired with an electrical current used to lock a door or device. The locking mechanism is prevented from moving unless an electromagnetic force is used to gain access. In the present invention, when the shackle (or bolt) 10 is locked into the body 20, the solenoid fits in the lock cavity and expands so that the device cannot be unlocked by sheer force. When the device is in the locked position, no power is used. The device only needs power when unlocking, so very little energy is ever required by the solenoid locking mechanism. As such, the present invention may run off a simple power source such as battery power.

A timing device is used to control the locking mechanism. The timing device also may run off a power source such as battery power. If the batteries are removed, the current time is stored into a memory device and the timing device will resume operation once the batteries are replaced.

The user operates the timing device programmable buttons 40 (hours/days) and 60 (hours/minutes) and display unit 30 to set the time that the locking mechanism will release the shackle 10 from the body 20 via the locking mechanism. Once the time is set, the user presses the lock button 50 to lock the device. Timing devices and how to operate and set the time for an “alarm” is well known in the prior art, wherein the programmable buttons 40 and 60 may represent “minutes” and “hours” for setting an alarm time. However, in the preferred embodiment of the present invention, rather than triggering an alarm, the timing device will either disengage the bolt from the housing via the motorized actuator or trigger a pulse of electromagnetic energy from a power source in the solenoid actuator described above to trigger the lock to release the shackle (or bolt) 10 from the body 20.

The timer can be reset by pressing both the left button 40 “hour” and right button 60 “minute” buttons at the same time. As soon as the time has been programmed and the lock button 50 has been pressed, the countdown cannot be aborted unless the user initiates an abort sequence (such as pressing both left button 40 and right button 60 simultaneously) during the 5 second buffer period. If the abort sequence is not pressed, the timer will begin countdown.

For example, if the lock is set for 1 hour, the timer will look like this: 01:00:05 (five second buffer). As soon as the start button 50 is pressed the timer will show 01:00:05 and begin count down, at 00:59:59. There are no overrides, there is no abort, and the lock cannot be opened until the time has expired unless both the hours button 40 and minutes button 60 are pressed within the 5 second buffer period.

As soon as the time is set and the lock button 50 is pressed, the shackle will be locked in place, and will not be able to be released unless the “abort” function described above is used during the 5 second window or until the time has expired.

In the preferred embodiment of the present invention, no overrides to the locking system are allowed, as it defeats the purpose of “locking out” user distractions. However, if the user inputs the wrong lock trigger time the user may have a window of time to cancel the operation.

The programmable buttons 40 and 60 and lock button 50 may make an audible noise when pressed. The user may use the mute button 70 located on the exterior of the housing 20 and opposite the programmable buttons 40 and 60 to silence the noise.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An electrically operated lockset comprising
a. A lock bolt;
b. A lock housing;
c. A mechanical lockset capable of being locked and unlocked by a lock actuator;
d. A plurality of programmable buttons on the exterior of the lock housing to electrically control a lock actuator fitted within the lock housing to operate a locking element moveable from a locked position to an unlocked position;
e. A timing mechanism countdown controlled by the programmable buttons; and
f. A display screen for a timing countdown

2. The electrically operated lockset of claim 1 wherein the lock bolt is removably fastenable to the lock housing.

3. The electrically operated lockset of claim 1 wherein the lock actuator is motorized.

4. The electrically operated lockset of claim 3 wherein the motion of the motor converts into the motion needed to move the bolt from the locked position to the locked position and from unlocked position to the locked position.

5. The electrically operated lockset of claim 1 further comprising locking solenoid, a locking cavity and a power source.

6. The electrically operated lockset of claim 4 wherein the locking solenoid fits in the lock cavity and expands to lock the bolt and the bolt is prevented from moving unless an electromagnetic force is used to release the solenoid from the lock cavity.

7. The electrically operated lockset of claim 1 further comprising a battery wherein the lock actuator and programmable buttons are operable by said battery.

8. The electrically operated lockset of claim 7 wherein once the programmable buttons are used to program the timing countdown, the lock remains in the locked position until the countdown reaches zero.

9. The electrically operated lockset of claim 7 wherein once the programmable buttons are used to program the timing countdown, the lock remains in the locked position until the countdown reaches zero unless an abort sequence is programmed within five seconds of starting the timing countdown.

10. The electrically operated lockset of claim 1 wherein the lock housing substantially surrounds the motor and the display screen is on an exterior surface of the lock housing.

11. The electrically operated lockset of claim 1 wherein the programmable buttons emit an audible noise.

12. The electrically operated lockset of claim 11 further comprising a mute button on the exterior of the lock housing that may be pressed to mute the audible noise.

13. The electrically operated lockset of claim 1 wherein the lock housing is substantially rectangular in shape.

14. The electrically operated lockset of claim 1 wherein the lock housing is substantially oval in shape.

15. The electrically operated lockset of claim 1 wherein the lock housing material is comprised of plastic coated wire, polymeric materials, zinc alloy, aluminum, stainless steel, rubber or combinations thereof.

16. A method for time delay of an electronic lock set, the method comprising the steps of
a. Locking an electrically operated lockset;
b. Setting a time delay period;
c. Releasing the lock bolt from the lock housing at the end of the time delay period.

17. The method of claim 16 wherein the locking device comprises
a. A lock bolt;
b. A lock housing;
c. A mechanical lockset capable of being locked and unlocked by a lock actuator;
d. A plurality of programmable buttons on the exterior of the lock housing to electrically control a lock actuator fitted within the lock housing to operate a locking element moveable from a locked position to an unlocked position;
e. A timing mechanism countdown controlled by the programmable buttons; and
f. A display screen for a timing countdown.

18. The method of claim 17 wherein the lock actuator is motorized.

19. The method of claim 17 wherein the electrically operated lockset further comprises a locking solenoid, a locking cavity and a power source.

20. The method of claim 19 wherein the locking solenoid fits in the lock cavity and expands to lock the bolt and the bolt is prevented from moving unless an electromagnetic force is used to release the solenoid from the lock cavity.
